(19) United States
(12) Patent Application Publication
(10) Pub. No.: US 2024/0291634 A1
(43) Pub. Date: Aug. 29, 2024

(54) Label Authenticity Verification Method and System

(71) Applicant: MAXIM SMART MANUFACTURING CO., LTD., Jiashan (CN)

(72) Inventor: Shendao ZHAI, Jiashan (CN)

(21) Appl. No.: 18/589,167

(22) Filed: Feb. 27, 2024

(30) Foreign Application Priority Data
Feb. 28, 2023 (CN) 202310214133.8

(51) Int. Cl. H04L 9/06

(52) U.S. Cl. CPC H04L 9/0618

(57) ABSTRACT

The present disclosure provides a label authenticity verification method and system, dual verification is carried out through a first service unit and a second service unit, the first service unit is firstly used for decomposing a read parameter instead of directly entering a verification process, the read data is effectively prevented from being stolen, and the verification accuracy is improved through a data comparison verification process.

### CROSS-REFERENCE TO RELATED APPLICATION

This application claims priority from the Chinese patent application 202310214133.8 filed Feb. 28, 2023, the content of which is incorporated herein in the entirety by reference.

### TECHNICAL FIELD

The present disclosure belongs to the field of verification, and in particular relates to a label authenticity verification method and a system thereof.

### BACKGROUND

The anti-counterfeiting label is generally used for high-value products, and its function is to prevent counterfeiting or to prove product warranty. In the early days, it is used for electronic products. Manufacturers will print serial numbers or warning contents on product stickers. With the progress of science and technology, the anti-counterfeiting label technology is changing with each passing day, and the chip anti-counterfeiting technology is developed. The verification information can be obtained by reading the chip through mobile phones or other electronic devices, and then whether it is genuine or not can be known. However, when reading through the chip, it is easy to steal the relevant data read through the network, resulting in the chip being counterfeited. To prevent the chip from being counterfeited, the disclosure provides a label authenticity verification method and a system thereof, which can effectively prevent the external stealing and reading of the relevant data.

### SUMMARY

An object of the present disclosure is to provide a label authenticity verification method, which effectively prevents data obtained at the time of reading from being leaked when reading a chip through double encryption and verification.

Another object of the present disclosure is to provide a label authenticity verification system which performs the aforementioned method to improve security of the anti-counterfeiting label.

In order to achieve the above objects, the present disclosure provides a label authenticity verification method, including the steps of:
reading a label chip to obtain a read parameter;
decomposing the read parameter to obtain ciphertext data and link data;
decrypting the ciphertext data to obtain corresponding first plaintext data;
decrypting the link data to obtain corresponding second plaintext data; and
comparing the first plaintext data with the second plaintext data to generate a verification result, the verification result being verification passed when the first plaintext data and the second plaintext data are the same and verification failed when the first plaintext data and the second plaintext data are different.

Preferably, the step of decrypting the ciphertext data to obtain the corresponding first plaintext data includes: comparing the ciphertext data in a cache database, when cache data in the cache database is consistent with the ciphertext data, obtaining the corresponding first plaintext data, when the cache data is inconsistent with the ciphertext data, transmitting the ciphertext data to a decryption server, and obtaining the corresponding first plaintext data through the decryption server.

Preferably, the first plaintext data includes first key data, first domain name data and label data, and the second plaintext data includes second key data and second domain name data.

Preferably, the step of decrypting the link data to obtain the corresponding second plaintext data includes: matching the label data of the first plaintext data, obtaining corresponding verification version data, decrypting the link data with the verification version data, and obtaining the second plaintext data.

Preferably, in the step of comparing the first plaintext data with the second plaintext data to generate the verification result, the verification result being verification passed when the first plaintext data and the second plaintext data are the same and verification failed when the first plaintext data and the second plaintext data are different, when the first plaintext data and the second plaintext data are the same, and a request number of a verification request instruction is not less than a read number of the label chip, the verification result is verification passed, and when the first plaintext data and the second plaintext data are different, or the request number is less than the read number, the verification result is verification failed.

In order to achieve another object, the present disclosure provides a label authenticity verification system, including:
a reading unit, used for reading a label chip to obtain a reading parameter;
a first service unit, in signal connection with the reading unit, used for receiving and decomposing the reading parameter to obtain ciphertext data and link data; and
a second service unit, in signal connection with the first service unit, used for receiving and respectively decrypting the ciphertext data and the link data to obtain corresponding first plaintext data and second plaintext data, and comparing the first plaintext data and the second plaintext data to generate a verification result.

Preferably, the second service unit includes a cache database, the second service unit compares the ciphertext data with cache data in a cache database, when the cache data is consistent with the ciphertext data, the corresponding first plaintext data is obtained, when the cache data is inconsistent with the ciphertext data, the ciphertext data is transmitted to a decryption server, and the corresponding first plaintext data is obtained through the decryption server.

Preferably, the first plaintext data includes first key data, first domain name data and label data, and the second plaintext data includes second key data and second domain name data.

Preferably, the second service unit matches the label data of the first plaintext data, obtains corresponding verification version data, decrypts the link data with the verification version data, and obtains the second plaintext data.

Preferably, the second service unit compares the first plaintext data, the second plaintext data, a request number of the verification request instruction, and a read number of the label chip, when the first plaintext data and the second plaintext data are the same, and the request number is not less than the read number, the verification result is verification passed, and when the first plaintext data and the second plaintext data are different, or the request number is less than the read number, the verification result is verification failed.

The disclosure has the beneficial effects that the verification flow of double verification is set, the accuracy of verification is improved, and the read data is effectively prevented from being stolen.

### BRIEF DESCRIPTION OF FIGURES

FIG. 1 is a schematic diagram of a system according to an embodiment of the present disclosure;

FIG. 2 is a flowchart of a method according to an embodiment of the present disclosure;

FIG. 3 is a flow diagram of an embodiment of the present disclosure; and

FIG. 4 is a schematic diagram of a verification result of an embodiment of the present disclosure.

### DETAILED DESCRIPTION

In order to make the above and/or other objects, effects and features of the present disclosure more readily understood, preferred embodiments are described in detail below.

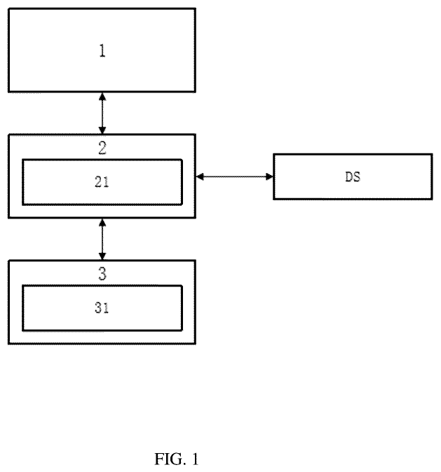

Please also refer to FIG. 1, which is a schematic diagram of a system according to an embodiment of the present disclosure. As shown in the drawing, a label authenticity verification system according to an embodiment of the present disclosure includes a reading unit 1, a first service unit 2 and a second service unit 3, and is described in detail as follows:

In an embodiment, the reading unit 1 can be a mobile phone device or other reading device, but is not limited thereto, and only needs to be able to read the label chip. The reading unit 1 of this embodiment takes the mobile phone device as an example, reads the label chip through the mobile phone device, and obtains the reading parameter. The reading parameter takes the Uniform Resource Locator (URL) link as an example, and clicks or automatically accesses the URL link to connect to the first service unit 2 by signal.

The first service unit 2 is in signal connection with the reading unit 1, the label chip is read through the mobile phone device, and the first service unit 2 is clicked or automatically accessed. The first service unit 2 receives and decomposes the reading parameter in the label chip to obtain the ciphertext data and the link data. In an embodiment, the first service unit 2 can be presented in the form of a web page, but is not limited thereto. Further, the first service unit 2 also includes a page buffer area 21, whether there is the same link data can be matched in the page buffer area 21, and if there is no consistent link data, the verification process is directly entered.

The second service unit 3 is in signal connection with the first service unit 2, the second service unit 3 receives and respectively decrypts the ciphertext data and the link data to obtain first plaintext data corresponding to the ciphertext data and second plaintext data corresponding to the link data, wherein the first plaintext data includes, but is not limited to, first key data, first domain name data and label data, in an embodiment, the label data is exemplified by a brand ID, but is not limited thereto, and the second plaintext data includes, but is not limited to, second key data and second domain name data.

In an embodiment, still further, the second service unit 3 further includes a cache database 31, the cache database 31 has a plurality of cache data, whether or not there is cache data that is consistent with the ciphertext data can be searched in the cache database 31. If there is no cache data consistent with the ciphertext data, the ciphertext data is transmitted to the decryption server DS, and the first plaintext data corresponding to the ciphertext data is obtained through the decryption server DS.

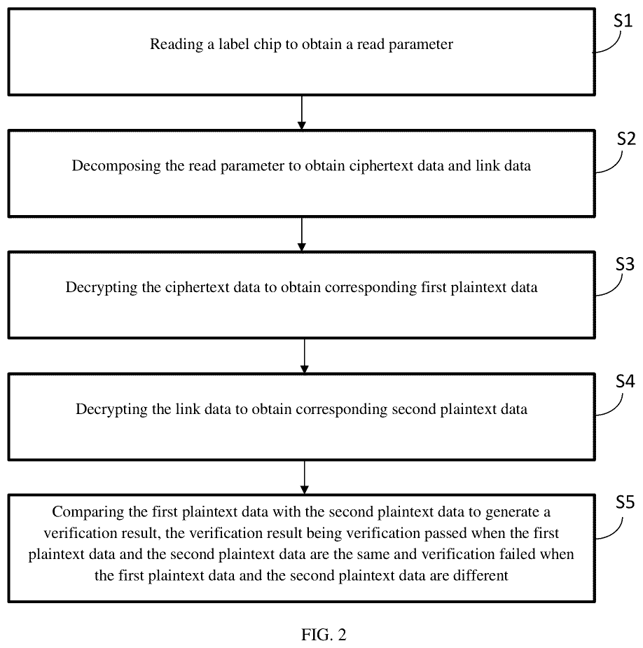

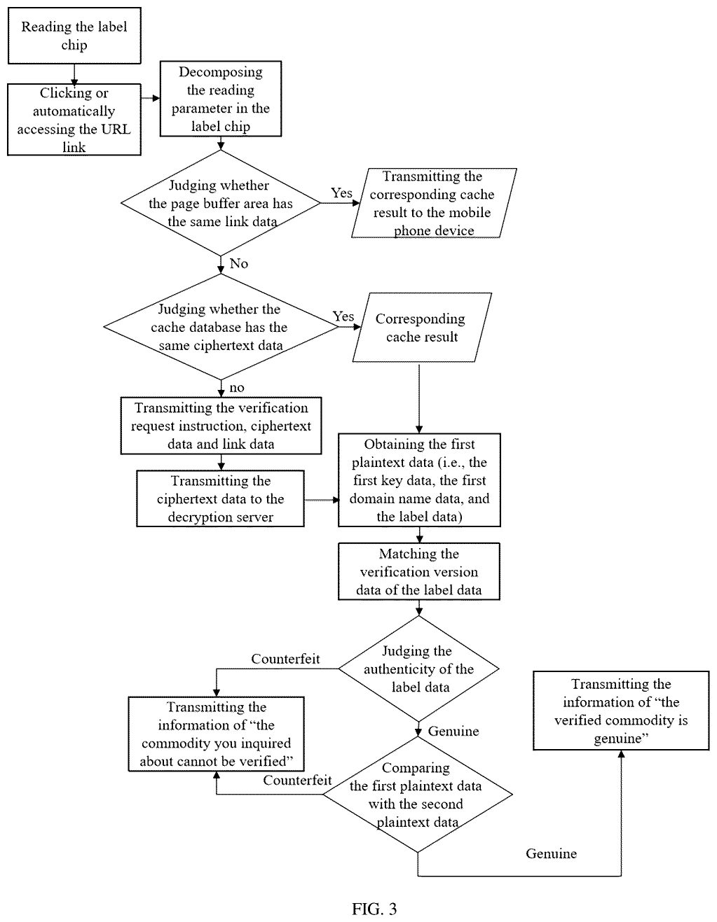

In order to provide a further understanding of the present disclosure, preferred embodiments of the present disclosure are described below with reference to the detailed description to facilitate the understanding of those skilled in the art. Referring now to FIGS. 2-3, a flowchart and a flow diagram of a method according to an embodiment of the present disclosure are shown. As shown in the drawings, the label authenticity verification method according to an embodiment of the present disclosure includes the following steps:
Step S1: a label chip is read to obtain a read parameter;
Step S2: the read parameter is decomposed to obtain ciphertext data and link data;
Step S3: the ciphertext data is decrypted to obtain corresponding first plaintext data;
Step S4: the link data is decrypted to obtain corresponding second plaintext data; and
Step S5: the first plaintext data is compared with the second plaintext data to generate a verification result, the verification result being verification passed when the first plaintext data and the second plaintext data are the same and verification failed when the first plaintext data and the second plaintext data are different.

As shown in step S1, in an embodiment, the data in the chip may be read using a cell phone device or other reading device, and the read parameter may be obtained.

As shown in step S2, after the first service unit 2 decomposes the read parameter, corresponding ciphertext data and link data may be obtained, still further, the obtained link data can be matched with the page buffer area 21 in the first service unit 2. When the same link data is matched, the result can be pulled directly and displayed on the mobile phone device without repeated verification, whereas if the same link data is not matched, a verification request instruction can be transmitted to enter the verification flow.

As shown in step S3, when a verification request instruction is received, the second service unit 3 decrypts the ciphertext data, prior to decrypting the ciphertext data, the ciphertext data may be first compared with the cache data of the cache database 31, and when the cache data is consistent with the ciphertext data, the corresponding first plaintext data may be obtained directly, whereas when the cache data is inconsistent with the ciphertext data, the ciphertext data is transmitted to the decryption server DS, and the first plaintext data corresponding to the ciphertext data is obtained by the decryption server DS.

As shown in step S4, the second service unit 3 decrypts the link data, first, the second service unit 3 matches the label data in the first plaintext data to obtain the verification version data corresponding to the label data, decrypts the link data with the verification version data to obtain the second plaintext data. Further, the verification version data is to find the corresponding version according to the brand ID to the corresponding database table, so as to call the verification function to judge the authenticity of the brand ID and obtain the judgment result, but it is not limited to this.

As shown in step S5, when the judgment result is true, the first plaintext data and the second plaintext data are compared, i.e., the first key data and the second key data are compared, and the first domain name data and the second domain name data are compared to generate a verification result, wherein, when the first key data is consistent with the second key data, and the first domain name data is consistent with the second domain name data, the verification result is verification passed; on the contrary, when the first key data is inconsistent with the second key data, or/and the first domain name data is inconsistent with the second domain name data, the verification result is verification failed.

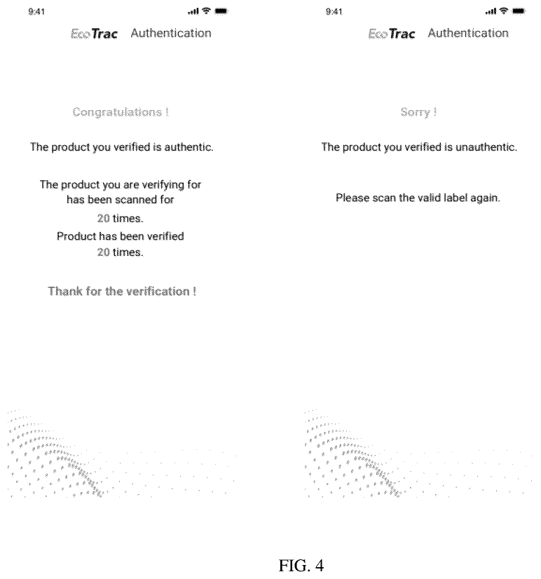

In one embodiment, further, in order to improve the accuracy of verification, the second service unit 3 compares the first plaintext data, the second plaintext data, a request number of the verification request instruction, and a read number of the label chip, when the first plaintext data and the second plaintext data are the same, and the request number is not less than the read number, the verification result is verification passed. When the verification passes, the information of “the verified commodity is genuine” can be transmitted correspondingly, and the request number and the read number are displayed. When the first plaintext data and the second plaintext data are different, or the request number is less than the read number, the verification result is verification failed. When the verification fails, the information of “the commodity you inquired about cannot be verified” can be transmitted correspondingly. The verification result is shown in FIG. 4, but it is not limited to this. This method can not only compare the plaintext data, but also further confirm whether there is an abnormal request through the read number and the request number, thus realizing accurate verification.

To sum up, an embodiment of the disclosure further decomposes the reading parameter by the first service unit instead of directly entering the verification process, that is, the verification process of double verification is completed by the first service unit and the second service unit, so as to improve the accuracy of verification and effectively prevent the read data from being stolen.

The foregoing is only the preferred embodiments of the present disclosure, and it should be noted that several improvements and modifications can be made by those skilled in the art without departing from the concept of the present disclosure, which should also be regarded as

What is claimed is:

1. A label authenticity verification method, comprising the steps of:
reading a label chip to obtain a read parameter;
decomposing the read parameter to obtain ciphertext data and link data;
decrypting the ciphertext data to obtain corresponding first plaintext data;
decrypting the link data to obtain corresponding second plaintext data; and
comparing the first plaintext data with the second plaintext data to generate a verification result, the verification result being verification passed when the first plaintext data and the second plaintext data are the same and verification failed when the first plaintext data and the second plaintext data are different.

2. The label authenticity verification method according to claim 1, wherein, the step of decrypting the ciphertext data to obtain the corresponding first plaintext data comprises: comparing the ciphertext data in a cache database, when cache data in the cache database is consistent with the ciphertext data, obtaining the corresponding first plaintext data, when the cache data is inconsistent with the ciphertext data, transmitting the ciphertext data to a decryption server, and obtaining the corresponding first plaintext data through the decryption server.

3. The label authenticity verification method according to claim 1, wherein, the first plaintext data comprises first key data, first domain name data and label data, and the second plaintext data comprises second key data and second domain name data.

4. The label authenticity verification method according to claim 1, wherein, the step of decrypting the link data to obtain the corresponding second plaintext data comprises: matching the label data of the first plaintext data, obtaining corresponding verification version data, decrypting the link data with the verification version data, and obtaining the second plaintext data.

5. The label authenticity verification method according to claim 1, wherein, in the step of comparing the first plaintext data with the second plaintext data to generate the verification result, the verification result being verification passed when the first plaintext data and the second plaintext data are the same and verification failed when the first plaintext data and the second plaintext data are different, when the first plaintext data and the second plaintext data are the same, and a request number of a verification request instruction is not less than a read number of the label chip, the verification result is verification passed, and when the first plaintext data and the second plaintext data are different, or the request number is less than the read number, the verification result is verification failed.

6. A label authenticity verification system, comprising:
a reading unit, used for reading a label chip to obtain a reading parameter;
a first service unit, in signal connection with the reading unit, used for receiving and decomposing the reading parameter to obtain ciphertext data and link data; and
a second service unit, in signal connection with the first service unit, used for receiving and respectively decrypting the ciphertext data and the link data to obtain corresponding first plaintext data and second plaintext data, and comparing the first plaintext data and the second plaintext data to generate a verification result.

7. The label authenticity verification system according to claim 6, wherein, the second service unit comprises a cache database, the second service unit compares the ciphertext data with cache data in a cache database, when the cache data is consistent with the ciphertext data, the corresponding first plaintext data is obtained, when the cache data is inconsistent with the ciphertext data, the ciphertext data is transmitted to a decryption server, and the corresponding first plaintext data is obtained through the decryption server.

8. The label authenticity verification system according to claim 6, wherein, the first plaintext data comprises first key data, first domain name data and label data, and the second plaintext data comprises second key data and second domain name data.

9. The label authenticity verification system according to claim 6, wherein, the second service unit matches the label data of the first plaintext data, obtains corresponding verification version data, decrypts the link data with the verification version data, and obtains the second plaintext data.

10. The label authenticity verification system according to claim 6, wherein, the second service unit compares the first plaintext data, the second plaintext data, a request number of the verification request instruction, and a read number of the label chip, when the first plaintext data and the second plaintext data are the same, and the request number is not less than the read number, the verification result is verification passed, and when the first plaintext data and the second plaintext data are different, or the request number is less than the read number, the verification result is verification failed.
